(19) United States
(12) Patent Application Publication
(10) Pub. No.: US 2011/0098906 A1
(43) Pub. Date: Apr. 28, 2011

(54) METHOD TO CHARACTERIZE AND CONTROL THE FLOW RATE OF A PULSE WIDTH MODULATING FUEL INJECTOR

(75) Inventors: Eric O. Barrows, Richmond, MI (US); Steven L. Ambrose, Farmington Hills, MI (US)

(73) Assignee: Eaton Corporation, Cleveland, OH (US)

(21) Appl. No.: 12/607,155

(22) Filed: Oct. 28, 2009

(51) Int. Cl. F02D 41/30

(52) U.S. Cl. 701/104

(57) ABSTRACT

A method of controlling a pulse width modulated fuel injector includes pumping fuel to the fuel injector with a variable-pressure fuel supply and commanding a mass flow. The method measures an actual fuel pressure of the variable-pressure fuel supply and adapts a duty cycle command for the fuel injector based upon an open loop calculation that utilizes both the commanded mass flow and the measured actual fuel pressure. The method may be characterized by an absence of controlling the actual fuel pressure of the variable-pressure fuel supply and may be further characterized by an absence of control by an electro-hydraulic regulator. The open loop calculation may use at least two coefficients.

### TECHNICAL FIELD

This disclosure relates to fuel injectors.

### BACKGROUND OF THE INVENTION

Fuel injection is one method for supplying fuel to the combustion process in internal combustion engines. Fuel injection atomizes the fuel by forcibly pumping it through a small nozzle under high pressure. The fuel injector acts as the fuel-dispensing nozzle and injects liquid fuel directly into the engine's air stream or, in the case of engine aftertreatment, into the exhaust stream. Pulse width modulation may be used to control the operation of solenoids used in the fuel injector. Pulse width modulation involves modulating a rectangular pulse wave by varying the pulse width, thereby varying the average value of the waveform.

### SUMMARY

A method of controlling a pulse width modulated fuel injector includes pumping fuel to the fuel injector with a variable-pressure fuel supply and commanding a mass flow. The method measures an actual fuel pressure of the variable-pressure fuel supply. A duty cycle command is adapted for controlling the fuel injector based upon an open loop calculation that utilizes both the commanded mass flow and the measured actual fuel pressure.

The method may be characterized by an absence of controlling the actual fuel pressure of the variable-pressure fuel supply, and may be further characterized by an absence of control by an electro-hydraulic regulator. The open loop calculation may utilize at least two coefficients.

The above features and advantages and other features and advantages of the present invention are readily apparent from the following detailed description of the best modes and other embodiments for carrying out the invention when taken in connection with the accompanying drawings.

### BRIEF DESCRIPTION OF THE DRAWINGS

FIG. 1 is a schematic diagram of a fuel injector control system for controlling a pulse width modulated (PWM) fuel injector;

FIG. 2 is a schematic logic diagram for part of an open loop calculation to determine a duty cycle for the PWM fuel injector

FIG. 3 is a schematic flow chart of a method or algorithm for controlling operation of the PWM fuel injector;

FIG. 4 is a schematic three-dimensional graph of the operating characteristics of the PWM fuel injector; and

FIG. 5 is a schematic flow chart of a method or algorithm for characterizing the PWM fuel injector.

### DESCRIPTION OF PREFERRED EMBODIMENTS

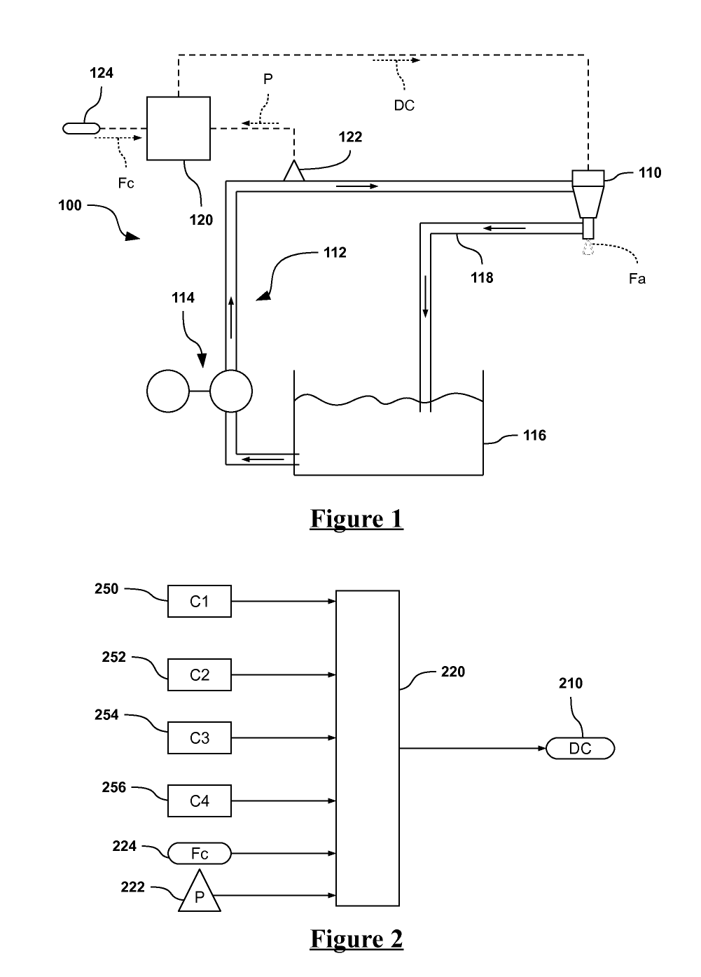

Referring to the drawings, wherein like reference numbers correspond to like or similar components throughout the several figures, there is shown in FIG. 1 a schematic diagram of a fuel injector control system 100. A pulse width modulated (PWM) fuel injector 110 is in fluid communication with a variable-pressure fuel supply 112. The fuel injector 110 sprays or doses fuel, which is used in an internal combustion engine (not shown).

The variable-pressure fuel supply 112 includes a pump 114 that pumps fuel to the fuel injector 110. The pump 114 draws fuel from a fuel tank 116 and supplies pressurized fuel to the fuel injector 110. A return path 118 returns unused fuel from the fuel injector 110 to the fuel tank 116.

The variable-pressure fuel supply 112 is characterized by an absence of structure or capability to control an actual fuel pressure P of the variable-pressure fuel supply 112. One structure capable of controlling the fuel pressure P is an electro-hydraulic regulator. However, the variable-pressure fuel supply 112 is characterized by an absence of control by an electro-hydraulic regulator.

Depending upon the characteristics of the pump 114, the fuel pressure P may vary greatly. The variance in fuel pressure P may be caused by changes in the power or torque supplied to the pump 114, the demands of other fuel systems or sub-systems drawing fuel from the same variable-pressure fuel supply 112, or other effects on the fuel pump 114 and variable-pressure fuel supply 112 as would be recognized by one having ordinary skill in the art. The fuel injector control system 100 may include a coarse pressure control mechanism to ensure that the fuel pressure P reaching the fuel injector does not exceed a maximum level or stays within an allowable operating range, such as, without limitation: a mechanical pressure regulator, a check relief valve, or other flow control device between the pump 114 and the fuel injector 110.

The air/fuel ratio is precisely controlled to achieve the desired engine performance, emissions, driveability, and fuel economy. Therefore, the amount of fuel injected by the fuel injector 110 is also tightly controlled. A controller 120 is in electrical communication with the fuel injector 110 to control an actual mass flow Fa from the fuel injector 110. Ideally, the actual mass flow will be equal to a commanded mass flow Fc.

The actual mass flow Fa is effected by the fuel pressure P in the variable-pressure fuel supply 112, the operating characteristics of the fuel injector 110, and a duty cycle DC controlling the fuel injector 110. The controller 120 outputs the duty cycle DC which it determines will make actual mass flow Fa substantially equal to commanded mass flow Fc.

In a PWM fuel injector, such as the fuel injector 100, the duty cycle DC is the proportion of on time to off time of the PWM wave. Power delivery with PWM can be used to reduce the total amount of power delivered to a load, in this case the fuel injector 110. This is because the average power delivered is proportional to the modulation duty cycle. Generally, a low duty cycle corresponds to low power because the power is off for most of the time. Duty cycle DC may be expressed in percent, 100% being fully on and 0% being fully off.

The controller 120 is in electrical communication with a pressure sensor 122 and a fuel command module 124. The pressure sensor 122 is configured to sense the fuel pressure P within the variable-pressure fuel supply 112 and communicate the fuel pressure P to the controller 120. The fuel command module 124 may be a separate controller incorporated into the engine control unit (ECU) or other structure recognizable to those having ordinary skill in the art. Furthermore, the controller 120 and fuel command module 124 may be combined into a single module.

The fuel command module 124 determines the commanded mass flow Fc from at least one of the operating conditions of the engine (RPM, temperature, et cetera), the vehicle conditions (driver torque demands, air flow to the engine, ambient air temperatures, et cetera), and aftertreatment system conditions. The command mass flow Fc is communicated by the fuel command module 124 to the controller 120. As described herein, the controller determines the duty cycle DC for the fuel injector 110 from the (variable) fuel pressure P and the commanded mass flow Fc.

The controller 120 adapts the duty cycle DC of the fuel injector 110 based upon an open loop calculation from the fuel pressure P measured by the pressure sensor 122 and the command mass flow Fc. The open loop calculation utilizes both the commanded mass flow Fc and the measured fuel pressure P because both of these characteristics are variable in the fuel injector control system 100. The duty cycle DC results in an actual mass flow Fa from the fuel injector 110.

The fuel injector control system 100 shown may be duplicated multiple times on the same engine in order to control multiple fuel injectors 110. Furthermore, one or more fuel injector control systems 100 may be implemented to control multiple pumps 114, tanks 116, controllers 120, et cetera. Alternatively, a single fuel injector control system 100 may include multiple fuel injectors 110, and the controller 120 may be configured to calculate individual duty cycles DC for each of the multiple fuel injectors 110.

Referring now to FIG. 2, and with continued reference to FIG. 1, there is shown a schematic logic diagram for an equation 220 forming part of the open loop calculation used to adapt the duty cycle DC and produce a duty cycle signal 210. The equation 220 may be stored in readable memory incorporated into the controller 120.

The commanded mass flow Fc and fuel pressure P are inputs 224 and 222 to the equation 220, respectively. The open loop calculation further incorporates operating coefficients for the fuel injector 110. There are four coefficient inputs shown: C1, input 250; C2, input 252; C3, input 254; and C4, input 256. From the commanded mass flow Fc, the fuel pressure P, and the coefficients C1-C4, the equation 220 determines the duty cycle DC at which the fuel injector 110 should be operated and outputs the duty cycle signal 210. The equation 220 shown in FIG. 2 incorporates four coefficients C1-C4. However, additional or fewer coefficients may be used, and the invention is limited only as required by the appended claims.

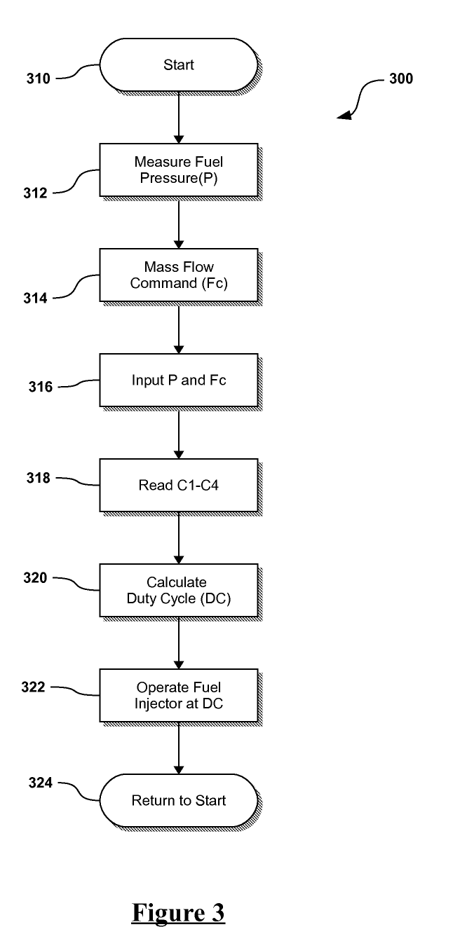

Referring now to FIG. 3, and with continued reference to FIGS. 1-2, there is shown a schematic flow chart of a method or algorithm 300 for controlling operation of a PWM fuel injector, such as the fuel injector 110 shown in FIG. 1. The algorithm may be executed by the controller 120 or another processing apparatus capable of receiving inputs and calculating the output duty cycle DC. The algorithm 300 begins at an initiation or start step, which may include powering up the controller 120 or turning on the engine.

For illustrative purposes, the algorithm 300 may be described with reference to the elements and components shown and described in relation to FIG. 1. However, those having ordinary skill in the art will recognize other components that may be used to practice the algorithm 300 and the invention as defined in the appended claims. Those having ordinary skill will further recognize that the exact order of the steps of the algorithm 300 shown in FIG. 3 is not required, and that steps may be reordered, steps may be omitted, and additional steps may be included.

At step 312, the algorithm 300 measures fuel pressure P within the variable-pressure fuel supply 112 with the pressure sensor 122. The commanded mass flow Fc is received from the fuel command module 124, which may be incorporated into the controller 120, at step 314. The algorithm 300 inputs the fuel pressure P and commanded mass flow Fc at step 316. The coefficients C1-C4 are read at step 318. The coefficients may already be stored on the controller 120 or may be retrieved from a storage medium located elsewhere.

At step 320, the algorithm 300 calculates the duty cycle DC by inputting the commanded mass flow Fc, fuel pressure P, and coefficients C1-C4 into the equation 220. At step 322, the controller 120 operates the fuel injector 110 at the calculated duty cycle DC by sending the duty cycle signal 210 to the fuel injector 110.

At step 324, the algorithm 300 then returns to the start step 310 to continue controlling the fuel injector based upon new measurements of fuel pressure P and new command mass flows Fc. The algorithm 300 may continuously loop in a cyclic fashion or may be running constantly to conduct instantaneous calculation of duty cycle DC for the fuel injector 110. The algorithm 300 may further calculate multiple duty cycles DC for multiple fuel injectors 110 fueling the same engine.

The coefficients C1-C4 may be generalized operating characteristics for all fuel injectors 110 manufactured for a specific application. However, due to manufacturing variations, the coefficients may also be unique to the specific, individual fuel injector 110 used in the fuel injector control system 100. Therefore, the fuel injector 110 will be characterized by its specific operating characteristics and a specific set of coefficients C1-C4 generated for that fuel injector 110.

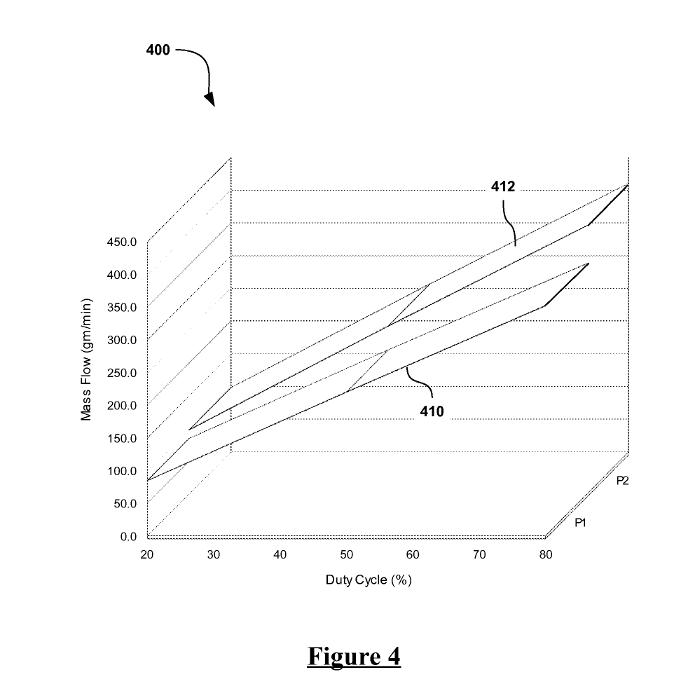

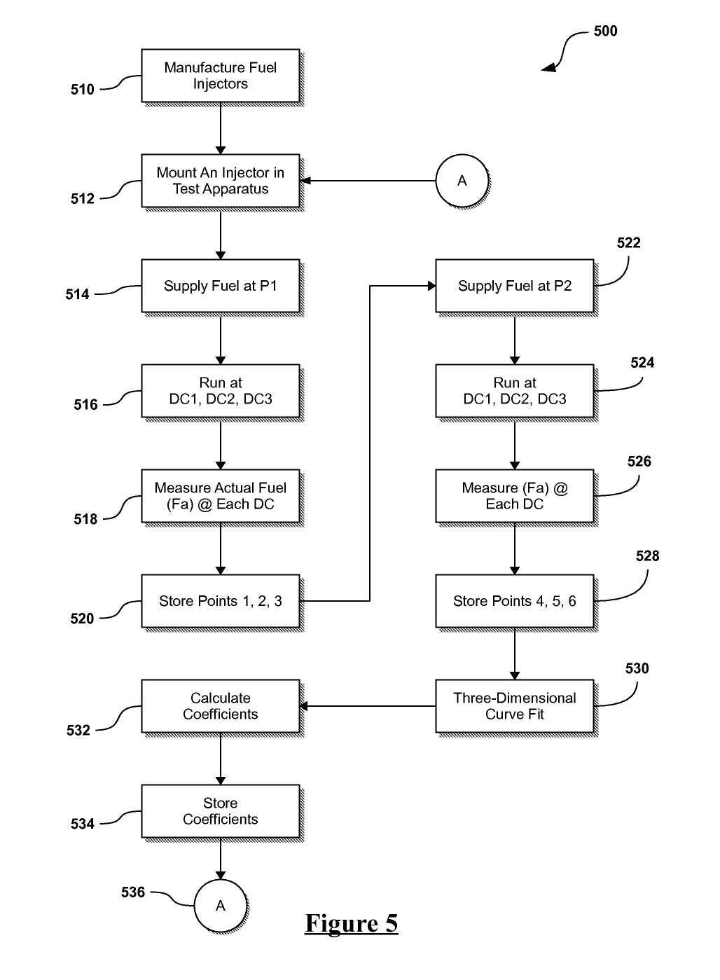

Referring now to FIGS. 4 and 5, and with continued reference to FIGS. 1-3, there is shown a method for characterizing fuel injectors 110. FIG. 4 shows a schematic three-dimensional graph 400 of the operating characteristics of one fuel injector 110. FIG. 5 shows a schematic flow chart of a method or algorithm 500 for characterizing a PWM fuel injector, such as the fuel injector 110 shown in FIG. 1. Characterizing fuel injectors refers, generally, to determination of the particular qualities, properties, or characteristics of individual fuel injectors.

The operating characteristics shown in FIG. 4 may be determined through controlled testing on a test stand, bench, or similar apparatus, and may be used to determine the coefficients C1-C4 for the fuel injector 110. The algorithm 500 includes manufacturing a plurality of fuel injectors 110 in step 510 and then loading or mounting one of the plurality of fuel injectors 110 into a test apparatus at step 512.

The graph 400 shows the fuel injector 110 operated at two fuel pressures. Operation at a first fixed fuel supply pressure P1 is shown on region 410, and operation at a second fixed fuel supply pressure P2 is shown on region 412. As shown in FIG. 5, the fuel injector 110 is supplied with fuel at the first fixed fuel supply pressure P1 at step 514.

Duty cycle DC, shown on the bottom axis of FIG. 4, may then be varied while holding the fuel pressure P constant. At step 516 the fuel injector 110 is controlled at a first predetermined duty cycle DC1, then a second predetermined duty cycle DC2, and then a third predetermined duty cycle DC3. At these discrete duty cycles DC1-DC3, the actual mass flow Fa is captured or otherwise measured as a function of fuel pressure P and duty cycle DC at step 518. This generates first, second, and third output mass flows Fa1, Fa2, and Fa3, which are stored at step 520.

The three mass flows Fa1-Fa3 define the region 410 shown in FIG. 4. The region 410 may also be expressed as an individual line connecting each of the data points, if the first fixed fuel supply pressure P1 was kept substantially constant. The fuel injector 110 is supplied with fuel at the second fixed fuel supply pressure P2 at step 522.

At step 524 the fuel injector 110 is again controlled at the discrete duty cycles DC1-DC3, and the actual mass flow Fa is measured as a function of fuel pressure P and duty cycle DC at step 526. This generates fourth, fifth, and sixth output mass flows Fa4, Fa5, and Fa6, which are stored at step 528. The three mass flows Fa4-Fa6 define the region 412 shown in FIG. 4, which may also be expressed as a straight line connecting each of the data points, if the second fixed fuel supply pressure P2 were kept substantially constant.

The results of the testing at each setting are the data which will be used to calculate the coefficients C1-C4 for the fuel injector 110. For example, after operating the fuel injector 110 at each of the first and second fixed fuel supply pressures P1 and P2 subjected to three discrete duty cycles DC1-DC3, respectively, the following chart shows the six resulting data points:

| Fixed Pressure | Duty Cycle | Actual Mass Flow |
|---|---|---|
| P1 | DC1 | Fa1 |
| P1 | DC2 | Fa2 |
| P1 | DC3 | Fa3 |
| P2 | DC1 | Fa4 |
| P2 | DC2 | Fa5 |
| P2 | DC3 | Fa6 |

From these data points, the coefficients C1-C4 may be calculated in step 532 by fitting a curve to the regions 410 and 412 to interpolate how the fuel injector 110 will react to other fuel pressures P and duty cycles DC. In the algorithm 500, the coefficients C1-C4 are determined by applying a three-dimensional curve fit at step 530. The coefficients C1-C4 may be determined with a three-dimensional, second order polynomial, such as, without limitation: DC(P,Fa)=C1+C2*P+C3*Fa+C4*P*Fa. With the second order polynomial and the six data points, the coefficients C1-C4 may be solved for by a least squares method. Additional three-dimensional, second order polynomials may also be used.

After the coefficients C1-C4 have been determined, they are put back into the second order polynomial and together form the equation 220 shown in FIG. 2. For exemplary purposes only, and without limitation, if (C1, C2, C3, C4)=(1, 2, 3, 4), the resulting equation 220 would be: DC(P,Fa)=1+2*P+3*Fa+4*P*Fa.

The equation 220 and the coefficients C1-C4 are loaded and stored in the controller 120 in step 534. The controller 120 reads the incoming commanded mass flow Fc and the measured fuel pressure P and calculates the duty cycle DC needed to operate the fuel injector 110 such that actual mass flow Fa will be substantially equal to commanded mass flow Fc.

As shown in FIG. 5, after the algorithm 500 determines and stores the coefficients C1-C4, another fuel injector 110 may be characterized to determine another set of coefficients C1-C4. At step 536, the algorithm 500 follows a return path A back to step 512 where another fuel injector 110 is loaded into the test apparatus and a substantial portion of the algorithm 500 repeats.

While the best modes and other embodiments for carrying out the claimed invention have been described in detail, those familiar with the art to which this invention relates will recognize various alternative designs and embodiments for practicing the invention within the scope of the appended claims.

1. A method of controlling a pulse width modulated fuel injector, comprising:
pumping fuel to the fuel injector with a variable-pressure fuel supply;
commanding a mass flow;
measuring an actual fuel pressure of the variable-pressure fuel supply; and
adapting a duty cycle command for the fuel injector based upon an open loop calculation, wherein the open loop calculation utilizes both the commanded mass flow and the measured actual fuel pressure.

2. The method of claim 1, further characterized by an absence of control over the actual fuel pressure of the variable-pressure fuel supply.

3. The method of claim 2, wherein the variable-pressure fuel supply is characterized by an absence of control by an electro-hydraulic regulator.

4. The method of claim 3, wherein the open loop calculation includes at least two coefficients, and the open loop calculation is derived by:
supplying the fuel injector with a first fixed fuel supply pressure;
controlling the fuel injector to a first predetermined duty cycle;
measuring a first output mass flow at the first predetermined duty cycle and the first fixed fuel supply pressure;
controlling the fuel injector to a second predetermined duty cycle;
measuring a second output mass flow at the second predetermined duty cycle and the first fixed fuel supply pressure;
supplying the fuel injector with a second fixed fuel supply pressure;
measuring a third output mass flow at the first predetermined duty cycle and the second fixed fuel supply pressure;
measuring a fourth output mass flow at the second predetermined duty cycle and the second fixed fuel supply pressure; and
calculating the at least two coefficients from the measured first, second, third, and fourth output mass flows.

5. The method of claim 4, wherein deriving the open loop calculation further includes:
controlling the fuel injector to a third predetermined duty cycle;
measuring a fifth output mass flow at the third predetermined duty cycle and the first fixed fuel supply pressure;
measuring a sixth output mass flow at the third predetermined duty cycle and the second fixed fuel supply pressure; and
calculating the at least two coefficients from the measured first, second, third, fourth, fifth, and sixth output mass flows.

6. The method of claim 5, wherein the open loop calculation includes at least four coefficients, and deriving the open loop calculation further includes calculating the at least four coefficients from the measured first, second, third, fourth, fifth, and sixth output mass flows.

7. The method of claim 6, wherein calculating the at least four coefficients includes fitting a second-order polynomial curve to the measured first through sixth output mass flows as a function of both the first through third predetermined duty cycles and the first through second fixed fuel supply pressures.

8. A method of characterizing a pulse width modulated fuel injector, comprising:
manufacturing a plurality of fuel injectors;
loading one of the plurality of fuel injectors into a test apparatus;
supplying the loaded fuel injector with a first fixed fuel supply pressure;
controlling the loaded fuel injector to a first predetermined duty cycle;
measuring a first output mass flow at the first predetermined duty cycle and the first fixed fuel supply pressure;
controlling the loaded fuel injector to a second predetermined duty cycle;
measuring a second output mass flow at the second predetermined duty cycle and the first fixed fuel supply pressure;
supplying the loaded fuel injector with a second fixed fuel supply pressure;
measuring a third output mass flow at the first predetermined duty cycle and the second fixed fuel supply pressure;
measuring a fourth output mass flow at the second predetermined duty cycle and the second fixed fuel supply pressure; and
calculating the at least two coefficients from the measured first, second, third, and fourth output mass flows.

9. The method of claim 8, wherein deriving the open loop calculation further includes:
controlling the loaded fuel injector to a third predetermined duty cycle;
measuring a fifth output mass flow at the third predetermined duty cycle and the first fixed fuel supply pressure;
measuring a sixth output mass flow at the third predetermined duty cycle and the second fixed fuel supply pressure; and
calculating the at least two coefficients from the measured first, second, third, fourth, fifth, and sixth output mass flows.

10. The method of claim 9, wherein the open loop calculation includes at least four coefficients, and deriving the open loop calculation further includes calculating the at least four coefficients from the measured first, second, third, fourth, fifth, and sixth output mass flows.

11. The method of claim 10, wherein calculating the at least four coefficients includes fitting a second-order polynomial curve to the measured first through sixth output mass flows as a function of both the first through third predetermined duty cycles and the first through second fixed fuel supply pressures.

12. The method of claim 11, further comprising loading the at least four coefficients into a computer readable medium.

13. The method of claim 8, further comprising loading the at least two coefficients into a computer readable medium.
